(19) United States
(12) Patent Application Publication
(10) Pub. No.: US 2016/0092430 A1
(43) Pub. Date: Mar. 31, 2016

(54) ELECTRONIC APPARATUS, METHOD AND STORAGE MEDIUM

(71) Applicant: Kabushiki Kaisha Toshiba, Tokyo (JP)

(72) Inventor: Shigeru Motoi, Kokubunji Tokyo (JP)

(21) Appl. No.: 14/668,848

(22) Filed: Mar. 25, 2015

(30) Foreign Application Priority Data
Sep. 30, 2014 (JP) 2014-200274

(51) Int. Cl. G06F 17/27; G06F 3/0484; G06F 17/24; G06F 3/0488

(52) U.S. Cl. CPC G06F 17/276; G06F 3/04883; G06F 3/04842; G06F 17/24

(57) ABSTRACT

According to one embodiment, an electronic apparatus is configured to display (1) a first set of first strokes specified based on at least one first stroke of the strokes and (2) a second set of second strokes specified based on at least one second stroke of the strokes as a candidate for handwriting input, the at least one second stroke different from the at least one first stroke. When the first set of first strokes or the second set of second strokes is selected, the at least one first stroke used to specify the first set of first strokes or the at least one second stroke used to specify the second set of second strokes is displayed visually distinguishable from other strokes of the strokes.

### CROSS-REFERENCE TO RELATED APPLICATIONS

This application is based upon and claims the benefit of priority from Japanese Patent Application No. 2014-200274, filed Sep. 30, 2014, the entire contents of which are incorporated herein by reference.

### FIELD

Embodiments described herein relate generally to an electronic apparatus, a method and a storage medium.

### BACKGROUND

Recently, various electronic apparatuses such as tablets, PDAs and smartphones have been developed. Many of these types of electronic apparatuses include a touchscreen display to facilitate an input operation by a user.

A user can operate an electronic apparatus by touching a menu or an object displayed on a touchscreen display with a finger, etc., or by performing handwriting input.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an outer appearance of an electronic apparatus according to one embodiment.

FIG. 2 shows a cooperative operation between the electronic apparatus of the embodiment and external devices.

FIG. 3 shows an example of a handwritten document handwritten on a touchscreen display of the electronic apparatus of the embodiment.

FIG. 4 is a figure for illustrating time-series data which is stored in a storage medium by the electronic apparatus of the embodiment and corresponds to the handwritten document of FIG. 3.

FIG. 5 is a block diagram showing a system configuration of the electronic apparatus of the embodiment.

FIG. 6 shows a structural element of a screen displayed on the touchscreen display of the electronic apparatus of the embodiment.

FIG. 7 shows a desktop screen displayed by a handwritten note application program in the electronic apparatus of the embodiment.

FIG. 8 shows a note preview screen displayed by the handwritten note application program in the electronic apparatus of the embodiment.

FIG. 9 shows a page editing screen displayed by the handwritten note application program in the electronic apparatus of the embodiment.

FIG. 10 shows a group of software buttons on the page editing screen displayed by the handwritten note application program in the electronic apparatus of the embodiment.

FIG. 11 is a block diagram showing an example of a function configuration of a handwritten note application in the electronic apparatus of the embodiment.

FIG. 12 shows an example of a data structure of a feature suggestion table.

FIG. 13 shows an example of a data structure of a keyword suggestion table.

FIG. 14 is a flowchart showing an example of feature amount registration processing.

FIG. 15 is a figure for specifically describing character integration recognition processing.

FIG. 16 is a flowchart showing an example of candidate presentation processing.

FIG. 17 is a figure for describing ranking of keywords.

FIG. 18 is a figure for describing a specific example of candidate presentation processing.

FIG. 19 is another figure for describing the specific example of the candidate presentation processing.

FIG. 20 is yet another figure for describing the specific example of the candidate presentation processing.

FIG. 21 is a figure for describing the specific example of the candidate presentation processing.

FIG. 22 is a figure for describing the specific example of the candidate presentation processing.

FIG. 23 shows an example of a data structure of a reading table.

### DETAILED DESCRIPTION

Various embodiments will be described hereinafter with reference to the accompanying drawings.

In general, according to one embodiment, an electronic apparatus include a circuitry. The circuitry is configured to input stroke data corresponding to strokes of handwriting. The circuitry is configured to display (1) a first set of first strokes specified based on at least one first stroke of the strokes and (2) a second set of second strokes specified based on at least one second stroke of the strokes as a candidate for handwriting input, the at least one second stroke different from the at least one first stroke. When the first set of first strokes or the second set of second strokes is selected, the at least one first stroke used to specify the first set of first strokes or the at least one second stroke used to specify the second set of second strokes is displayed visually distinguishable from other strokes of the strokes.

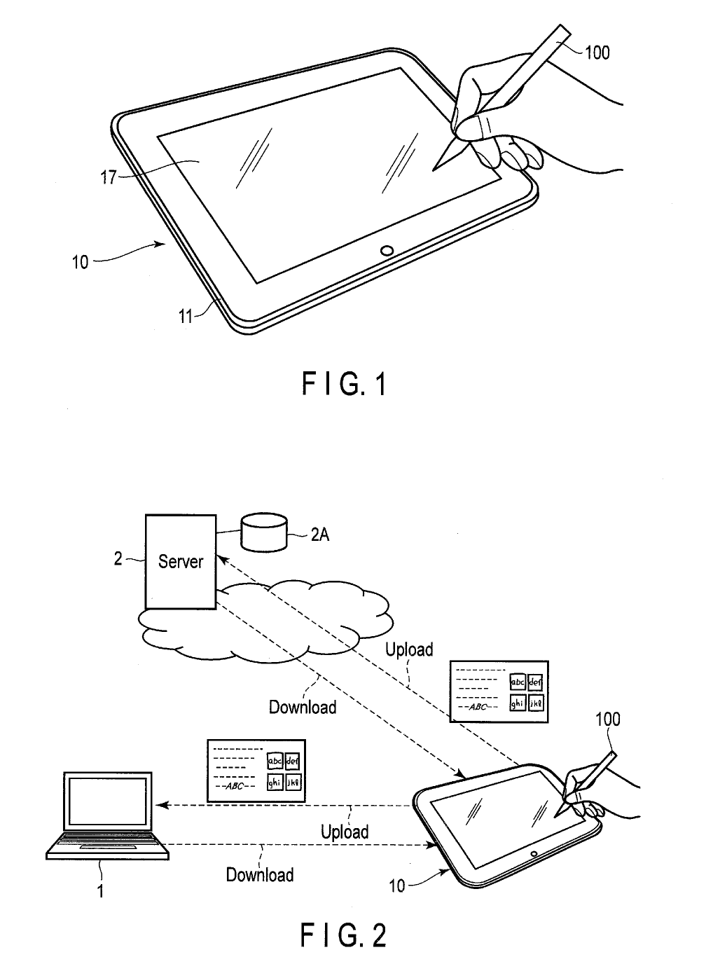

FIG. 1 is a perspective view showing an example of an outer appearance of an electronic apparatus according to an embodiment. The electronic apparatus is, for example, a stylus-based portable electronic apparatus enabling handwriting input with a stylus or a finger. The electronic apparatus can be realized as a tablet computer, a notebook computer, a smartphone, a PDA, etc. A case where the electronic apparatus is realized as a tablet computer 10 will be hereinafter described. The tablet computer 10 is a portable electronic apparatus also called a tablet or a slate computer, and a main body 11 includes a thin box housing.

A touchscreen display 17 is attached to an upper surface of the main body 11 in piles. A flat panel display and a sensor configured to detect a contact position of a stylus or a finger on a screen of the flat panel display are mounted in the touchscreen display 17. The flat panel display may be, for example, a liquid crystal display (LCD). As the sensor, for example, a capacitive touchpanel or an electromagnetic induction system digitizer can be used. A case where both of two kinds of sensors, that is, the digitizer and the touchpanel are mounted in the touchscreen display 17 will be hereinafter described. Thus, the touchscreen display 17 can detect not only a touch operation on a screen by use of a finger but that on the screen by use of a stylus 100.

The stylus 100 may be, for example, a digitizer stylus (electromagnetic induction stylus). A user can perform a handwriting input operation on the touchscreen display 17 using the stylus 100 (stylus input mode). In the stylus input mode, a locus based on motion of the stylus 100 on a screen, that is, a stroke handwritten by the handwriting input operation is required, and then a plurality of strokes input by handwriting are displayed on the screen. The locus of motion of the stylus 100 when the stylus 100 is in contact with the screen corresponds to a stroke. A plurality of strokes constitute a character, a symbol, etc. A set of a number of strokes corresponding to a handwritten character, a handwritten figure, a handwritten table, etc., constitute a handwritten document.

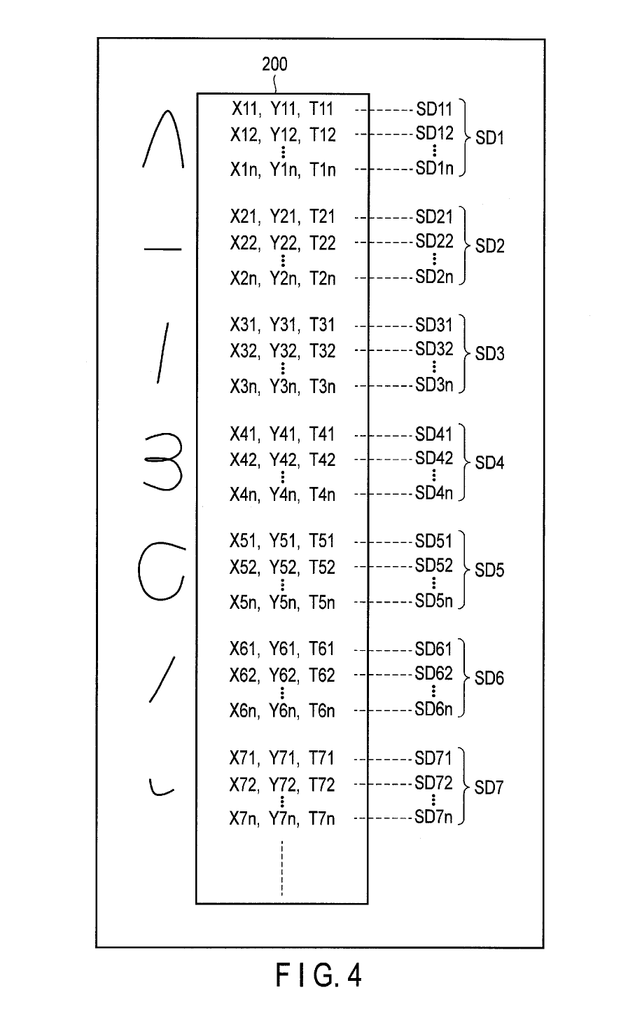

In this embodiment, the handwritten document is stored in a storage medium not as image data but as time-series data (handwritten document data) indicating an order relationship between a coordinate string of a locus of each stroke and a stroke. However, the handwritten document may be generated based on the image data. Although the time-series data will be described later in detail with reference to FIG. 4, it indicates an order in which a plurality of strokes are handwritten and includes a plurality of stroke data items corresponding to the plurality of strokes. In other words, the time-series data means a set of time-series stroke data items corresponding to the plurality of strokes. Each stroke data item corresponds to a stroke and includes a coordinate data series (time-series coordinates) corresponding to points on the locus of the stroke. The alignment order of the stroke data items corresponds to the order in which the strokes are handwritten.

The tablet computer 10 can read arbitrary existing time-series data from a storage medium, and display the handwritten document corresponding to the time-series data, that is, the plurality of strokes indicated by the time-series data on a screen. The plurality of strokes indicated by the time-series data are also the plurality of strokes input by handwriting.

Furthermore, the tablet computer 10 according to this embodiment also includes a touch input mode for performing the handwriting input operation with a finger without using the stylus 100. If the touch input mode is enabled, a user can perform the handwriting input operation on the touchscreen display 17 using a finger. In the touch input mode, a locus based on motion of a finger on a screen, that is, a stroke handwritten by the handwriting input operation is required, and then the plurality of strokes input by handwriting are displayed on the screen.

The tablet computer 10 includes an editing function. The editing function allows an arbitrary handwritten portion in a handwritten document being displayed (a handwritten character, a handwritten mark, a handwritten figure, a handwritten table, etc.) to be deleted or moved, the handwritten portion being selected by a range selection tool in accordance with a user's editing operation using an eraser tool, a range selection tool and other various tools. Also, an arbitrary handwritten portion selected by the range selection tool in the handwritten document can be specified as a retrieval key for retrieving the handwritten document. Also, recognition processing such as handwritten character recognition, handwritten figure recognition and handwritten table recognition can be performed on an arbitrary handwritten portion selected by the range selection tool in the handwritten document.

In this embodiment, the handwritten document can be managed as one or more pages. In this case, a group of time-series data fitting onto a screen may be stored as a page by partitioning the time-series data (handwritten document data) by area fitting onto the screen. Alternatively, the size of the page may be made variable. In this case, since the size of the page can be enlarged to include an area larger than the size of the screen, the handwritten document comprising an area larger than the size of the screen can be handled as a page. If a whole page cannot be displayed on a display at a time, the page may be reduced and displayed, or a portion to be displayed on the page may be moved by scrolling vertically or horizontally.

FIG. 2 shows an example of a cooperative operation between the tablet computer 10 and external devices. The tablet computer 10 includes a wireless communication device such as a wireless LAN, and can perform wireless communication with a personal computer 1. Furthermore, the tablet computer 10 can also perform communication with a server 2 on the Internet 3 using the wireless communication device. The server 2 may be a server configured to execute an online storage service or other various cloud computing services.

The personal computer 1 includes a storage device such as a hard disk drive (HDD). The tablet computer 10 can transmit the time-series data (handwritten document data) to the personal computer 1, and store it in the HDD of the personal computer 1 (upload). To ensure secure communication between the tablet computer 10 and the personal computer 1, the personal computer 1 may authenticate the tablet computer 10 at the time of starting communication. In this case, a dialogue for urging a user to enter an ID or a password may be displayed on a screen of the tablet computer 10, and an ID, etc., of the tablet computer 10 may be automatically transmitted from the tablet computer 10 to the personal computer 1.

This allows the tablet computer 10 to handle a lot of time-series data or large-volume time-series data even if the tablet computer 10 includes small-capacity storage.

Furthermore, the tablet computer 10 can read at least one arbitrary time-series data item stored in an HDD of the personal computer 1 (download) and display a stroke indicated by the read time-series data on a screen of a display 17 of the tablet computer 10. In this case, a list of thumbnails obtained by reducing a page of each of the plurality of time-series data items may be displayed on the screen of the display 17, and a page selected from the thumbnails may be displayed on the screen of the display 17 in a normal size.

Furthermore, a communication destination of the tablet computer 10 can be not only the personal computer 1 but the server 2 on the cloud that provides a storage service, etc., as described above. The tablet computer 10 can transmit the time-series data (handwritten document data) to the server 2 through the Internet, and store it in a storage device 2A of the server 2 (upload). Furthermore, the tablet computer 10 can read arbitrary time-series data stored in the storage device 2A of the server 2 (download) and display the locus of each stroke indicated by the time-series data on the screen of the display 17 of the tablet computer 10.

As shown above, in this embodiment, a storage medium in which the time-series data is stored may be the storage device in the tablet computer 10, the storage device in the personal computer 1 or the storage device 2A in the server 2.

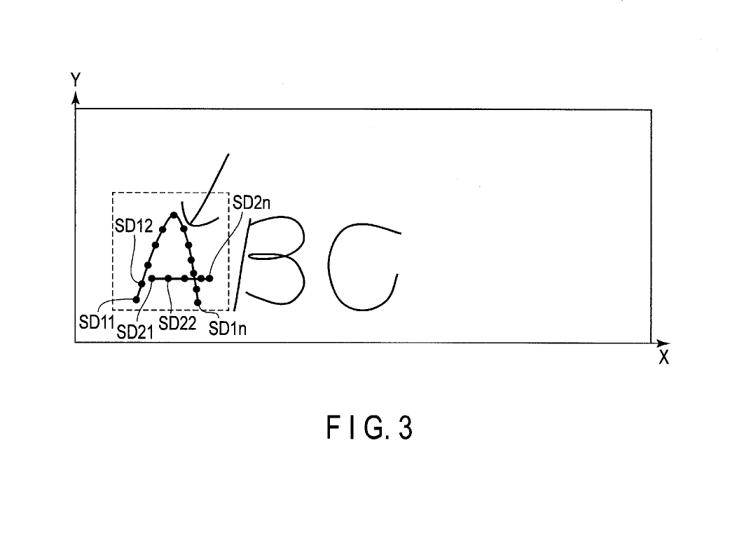

Next, the relationship between a stroke handwritten by a user (character, figure, table, etc.) and the time-series data will be described with reference to FIGS. 3 and 4. FIG. 3 shows an example of a handwritten document (handwritten character string) handwritten on the touchscreen display 17 using the stylus 100, etc.

In the handwritten document, there are many cases where a character, a figure or the like is once input by handwriting, and then another character, figure or the like is input on it by handwriting. In FIG. 3, handwritten characters “A”, “B” and “C” are input in this order by handwriting, and then a handwritten arrow is input by handwriting immediately near the handwritten character “A”.

The handwritten character “A” is expressed by two strokes (“Λ”-shaped locus and “-”-shaped locus) handwritten using the stylus 100, etc., that is, two loci. The “Λ”-shaped locus of the stylus 100 which is first handwritten is sampled in real time, for example, at regular time intervals, and as a result, time-series coordinates SD11, SD12, . . . , SD1n of the “Λ”-shaped stroke can be obtained. Similarly, the “-”-shaped locus of the stylus 100 which is next handwritten is also sampled in real time at regular time intervals, and as a result, time-series coordinates SD21, SD22, . . . , SD2n of the “-”-shaped stroke can be obtained.

The handwritten character “B” is expressed by two strokes handwritten using the stylus 100, etc., that is, two loci. The handwritten character “C” is expressed by a stroke handwritten using the stylus 100, etc., that is, one locus. The handwritten arrow is expressed by two strokes handwritten using the stylus 100, etc., that is, two loci.

FIG. 4 shows time-series data 200 corresponding to the handwritten document shown in FIG. 3. The time-series data includes a plurality of strokes data items SD1, SD2, . . . , SD7. In the time-series data 200, the stroke data items SD1, SD2, . . . , SD7 are arranged in time series in an order in which the strokes are handwritten.

In the time-series data 200, the first two stroke data items SD1 and SD2 indicate two strokes of the handwritten character “A”. The third and fourth stroke data items SD3 and SD4 indicate two strokes constituting the handwritten character “B”. The fifth stroke data item SD5 indicates a stroke constituting the handwritten character “C”. The sixth and seventh stroke data items SD6 and SD7 each indicate two strokes constituting the handwritten arrow.

Each stroke data item includes a coordinate data series (time-series coordinates) corresponding to a stroke, that is, a plurality of coordinates corresponding to a plurality of sampling points on a locus of a stroke. In each stroke data item, the plurality of coordinates corresponding to the sampling points are arranged in time series in the order in which the strokes are written (sampled). Regarding, for example, the handwritten character “A”, the stroke data item SD1 includes a coordinate data series (time-series coordinates) corresponding to points on the locus of the “Λ”-shaped stroke of the handwritten character “A”, that is, n coordinate data items SD11, SD12, . . . , SD1n. The stroke data item SD2 includes a coordinate data series corresponding to points on the locus of the “-”-shaped stroke of the handwritten character “A”, that is, n coordinate data items SD21, SD22, . . . , SD2n. It should be noted that the number of coordinate data items may be different for each stroke data item. When strokes are sampled at regular time intervals, the number of sampling points differs due to different lengths of the strokes.

Each coordinate data item indicates an X-coordinate and a Y-coordinate corresponding to a point on a corresponding locus. For example, coordinate data item SD11 represents the X-coordinate (X11) and Y-coordinate (Y11) at a start point of the “Λ”-shaped stroke. SD1n represents the X-coordinate (X1n) and Y-coordinate (Y1n) at an end point of the “Λ”-shaped stroke.

Each coordinate data item may include the time stamp data T corresponding to the time (sampling timing) when a point corresponding to the coordinate is handwritten. The handwritten time may be an absolute time (for example, year, month, day, hour, minute and second) or a relative time based on a specific time. For example, an absolute time (for example, year, month, day, hour, minute and second) when a stroke is first written may be added as time stamp data, and furthermore, a relative time indicating a difference from an absolute time may be added to each coordinate data item in the stroke data as time stamp data T.

As shown above, a time relationship between strokes can be accurately expressed using the time-series data in which the time stamp data T is added to each coordinate data item. Although it is not shown in FIG. 4, data (Z) indicating writing pressure may be added to each coordinate data item.

The time-series data 200 comprising a structure as described with reference to FIG. 4 can express not only handwritten script of each stroke but the time relationship between the strokes. Thus, the handwritten character “A” and the top of the handwritten arrow can be recognized as different characters or figures using the time-series data 200, even if the top of the handwritten arrow overlaps the handwritten character “A” or is adjacent to it, as shown in FIG. 3.

Furthermore, in this embodiment, since the handwritten document data is stored not as an image or a character recognition result but as the time-series data 200 constituted from a set of time-series stroke data items as described above, the handwritten character can be handled without depending on a language of the handwritten character. Thus, the structure of the time-series data 200 of this embodiment can be commonly used in various countries in the world in which different languages are used.

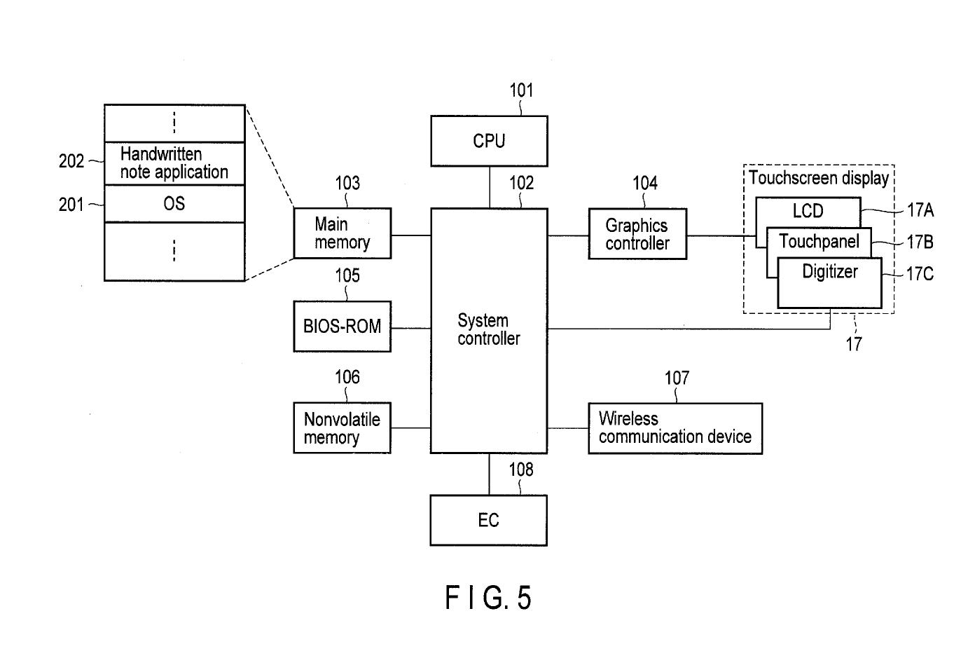

FIG. 5 shows a system configuration of the tablet computer 10.

The tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor configured to control an operation of various modules in the tablet computer 10. The CPU 101 executes various types of software loaded from the nonvolatile memory 106, which is a storage device, into the main memory 103. The software includes an operating system (OS) 201 and various application programs. The application programs include a handwritten note application program 202. The handwritten document data is also hereinafter referred to as a handwritten note. The handwritten note application program 202 includes a function of creating and displaying the handwritten document data, a function of editing the handwritten document data, and a handwritten document retrieval function of retrieving the handwritten document data comprising a desired handwritten portion or a desired handwritten portion in some handwritten document data.

The CPU 101 executes a basic input/output system (BIOS) stored in the BIOS-ROM 105. The BIOS is a program for hardware control.

The system controller 102 is a device configured to connect between a local bus of the CPU 101 and various component modules. A memory controller configured to perform access control on the main memory 103 is also mounted in the system controller 102. Also, the system controller 102 includes a function of performing communication with the graphics controller 104 through a serial bus, etc., conforming to the PCI EXPRESS standard.

The graphics controller 104 is a display controller configured to control an LCD 17A used as a display monitor of the tablet computer 10. A display signal generated by the graphics controller 104 is transmitted to the LCD 17A. The LCD 17A displays a screen image based on the display signal. The LCD 17A, a touchpanel 17B and a digitizer 17C are overlapped. The touchpanel 17B is a capacitance-style pointing device configured to perform input on a screen of the LCD 17A. A contact position of a finger on a screen and motion, etc., of the contact position are detected by the touchpanel 17B. The digitizer 17C is an electromagnetic induction-style pointing device configured to perform input on a screen of the LCD 17A. A contact position of the stylus (digitizer stylus) 100 on a screen and motion, etc., of the contact position are detected by the digitizer 17C.

The wireless communication device 107 is a device configured to perform wireless communication such as a wireless LAN and 3G mobile communication. An EC 108 is a single-chip microcomputer comprising an embedded controller for power management. The EC 108 includes a function of powering on or off the tablet computer 10 in accordance with the operation of a power button by a user.

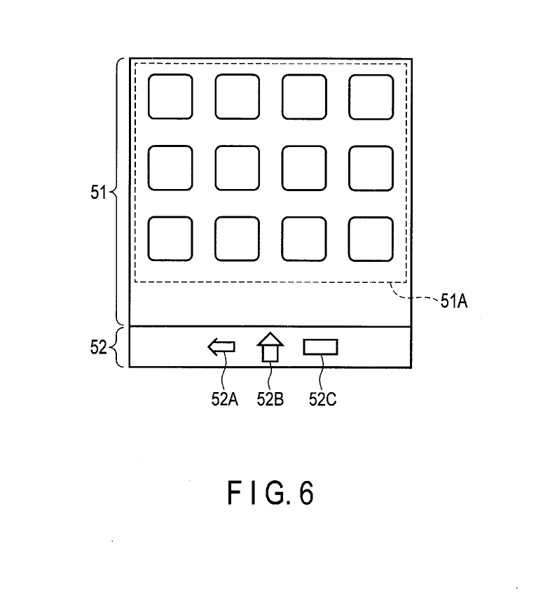

FIG. 6 shows a structural element of a screen displayed on the touchscreen display 17.

The screen includes a display area (also called content area) 51 and a bar (also called navigation bar) 52 below the display area 51. The display area 51 is an area for displaying contents. Contents of an application program in an active state are displayed on the display area 51. A case where a launcher program is in the active state is assumed in FIG. 6. In this case, a plurality of icons 51A corresponding to a plurality of application programs are displayed on the display area 51 by the launcher program.

It should be noted that an application program being active means that the application program is shifted to a foreground. In other words, it means that the application program is started and focused.

The bar 52 is an area for displaying at least one software button (also called software key) of the OS 201. A predetermined function is assigned to each software button. When a software button is tapped by a finger or the stylus 100, a function assigned to the software button is carried out by the OS 201. For example, in the Android (registered trademark) environment, a return button 52A, a home button 52B and a recent application button 52C are displayed on the bar 52, as shown in FIG. 6. The software buttons are displayed at a default display position on the bar 52.

Next, examples of some typical screens presented to a user by the handwritten note application program 202 will be described.

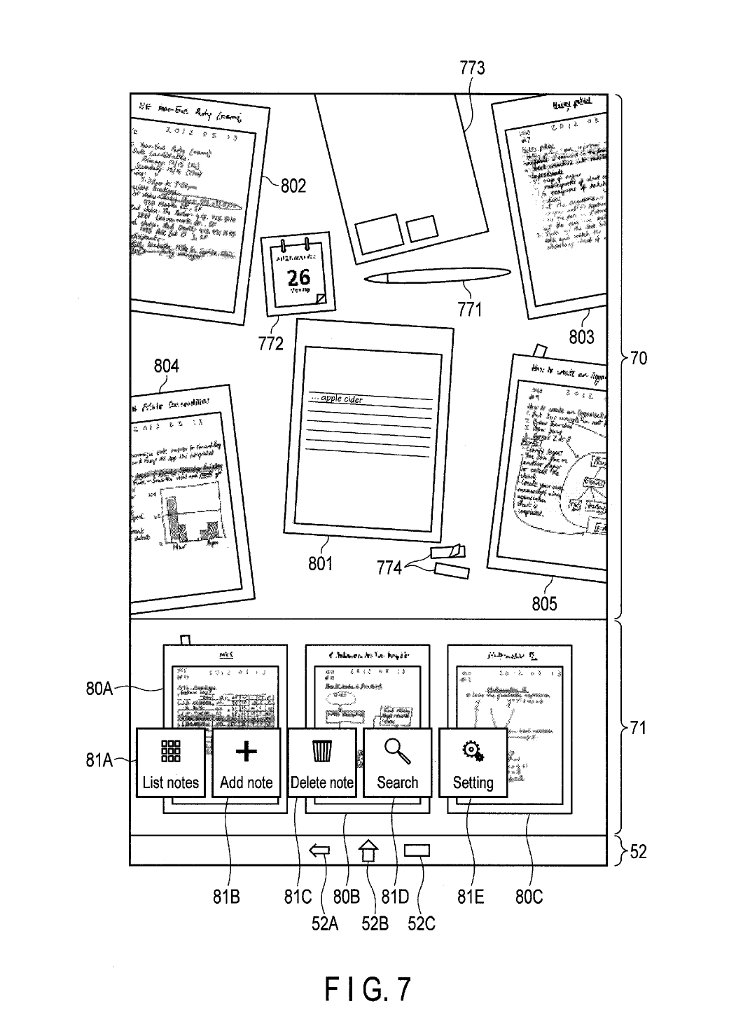

FIG. 7 shows a desktop screen displayed by the handwritten note application program 202. The desktop screen is a basic screen configured to handle a plurality of handwritten document data items.

The desktop screen includes a desktop screen area 70 and a drawer screen area 71. The desktop screen area 70 is a temporary area for displaying a plurality of note icons 801 to 805 corresponding to a plurality of handwritten notes being in a working state. Each of note icons 801 to 805 displays a thumbnail of a page in a corresponding handwritten note. The desktop screen area 70 further displays a stylus icon 771, a calendar icon 772, a scrap note (gallery) icon 773 and a tag (label) icon 774.

The stylus icon 771 is a graphical user interface (GUI) for switching a display screen from a desktop screen to a page editing screen. The calendar icon 772 is an icon for indicating a current date. The scrap note icon 773 is a GUI for browsing data (called scrap data or gallery data) captured from another application program or an external file. The tag icon 774 is a GUI for attaching a label (tag) on an arbitrary page in an arbitrary handwritten note.

The drawer screen area 71 is a display area for browsing a storage area for storing all of created handwritten notes. The drawer screen area 71 displays note icons 80A, 80B and 80C corresponding to some handwritten notes in all the handwritten notes. Each of note icons 80A, 80B and 80C displays a thumbnail on a page in a corresponding handwritten note. The handwritten note application program 202 can detect a gesture performed in the drawer screen area 71 by a user using the stylus 100 or a finger (for example, swipe gesture). The handwritten note application program 202 scrolls a screen image in the drawer screen area 71 leftward or rightward in response to the detection of the gesture (for example, swipe gesture). This allows a note icon corresponding to an arbitrary handwritten note to be displayed in the drawer screen area 71.

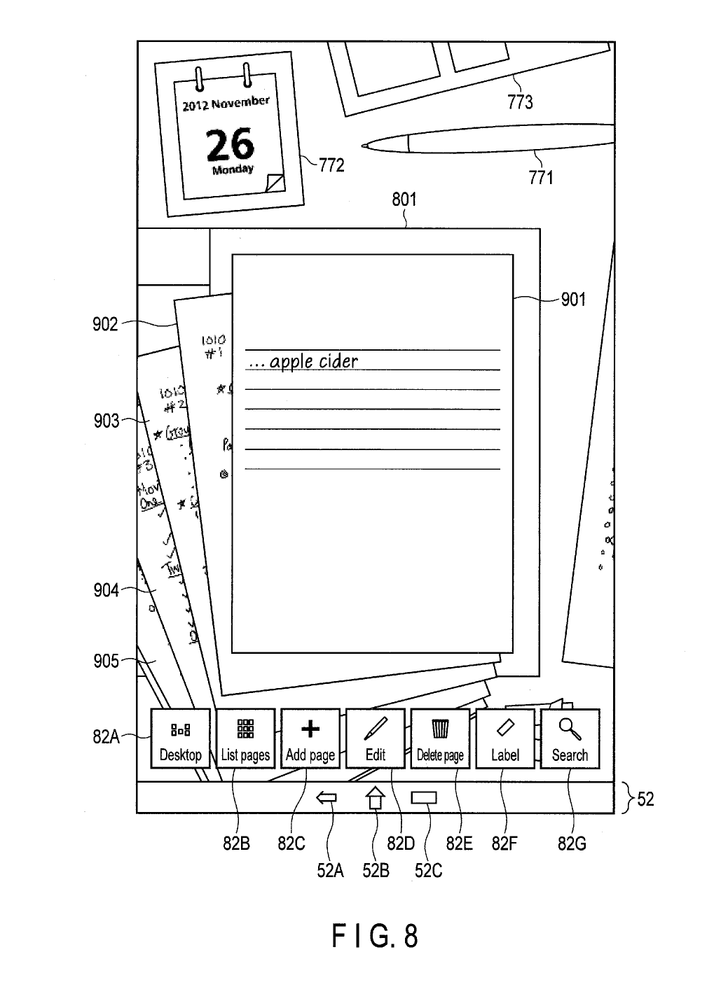

Furthermore, the handwritten note application program 202 can detect a gesture performed on the note icon of the drawer screen area 71 by a user using the stylus 100 or a finger (for example, tap gesture). The handwritten note application program 202 moves the note icon to a central portion of the desktop screen area 70 in response to the detection of a gesture on the note icon on the drawer screen area 71 (for example, tap gesture). Then, the handwritten note application program 202 selects a handwritten note corresponding to the note icon, and displays the note preview screen shown in FIG. 8 instead of a desktop screen. The note preview screen of FIG. 8 is a screen configured to browse an arbitrary page in the selected handwritten note.

Furthermore, the handwritten note application program 202 can detect a gesture performed on the desktop screen area 70 by a user using the stylus 100 or a finger (for example, tap gesture). The handwritten note application program 202 selects a handwritten note corresponding to a note icon located in a central portion, and displays the note preview screen shown in FIG. 8 instead of a desktop screen in response to the detection of the gesture on the note icon located in the central portion of the desktop screen area 70 (for example, tap gesture).

Furthermore, a menu can be displayed on the desktop screen. This menu includes a list note button 81A, a note addition button 81B, a note deletion button 81C, a search button 81D and a setting button 81E. The list note button 81A is a button for displaying a list of handwritten notes. The note addition button 81B is a button for preparing (adding) a new handwritten note. The note deletion button 81C is a button for deleting a handwritten note. The search button 81D is a button for opening a search screen (search dialogue). The setting button 81E is a button for opening a setting screen.

Also, the return button 52A, the home button 52B and the recent application button 52C are displayed on the bar 52.

FIG. 8 shows the above-described note preview screen.

The note preview screen is a screen configured to browse an arbitrary page in a selected handwritten note. Here, a case where a handwritten note corresponding to a note icon 801 is selected is assumed. In this case, the handwritten note application program 202 displays a plurality of pages 901 to 905 included in the handwritten note with the pages 901 to 905 overlapped such that at least part of each of the pages 901 to 905 can be viewed.

The stylus icon 771, the calendar icon 772, the scrap note icon 773 and the tag icon 774 are further displayed on the note preview screen.

A menu can be further displayed on the note preview screen. The menu includes a desktop button 82A, a list page button 82B, a page addition button 82C, a page edit button 82D, a page deletion button 82E, a label button 82F and a search button 82G. The desktop button 82A is a button for displaying the desktop screen. The list page button 82B is a button for displaying a list of pages in the currently-selected handwritten note. The page addition button 82C is a button for preparing (adding) a new page. The page edit button 82D is a button for displaying a page editing screen. The page deletion button 82E is a button for deleting a page. The label button 82F is a button for displaying a list of kinds of usable labels. The search button 82G is a button for displaying the search screen.

Also, the return button 52A, the home button 52B and the recent application button 52C are displayed on the bar 52.

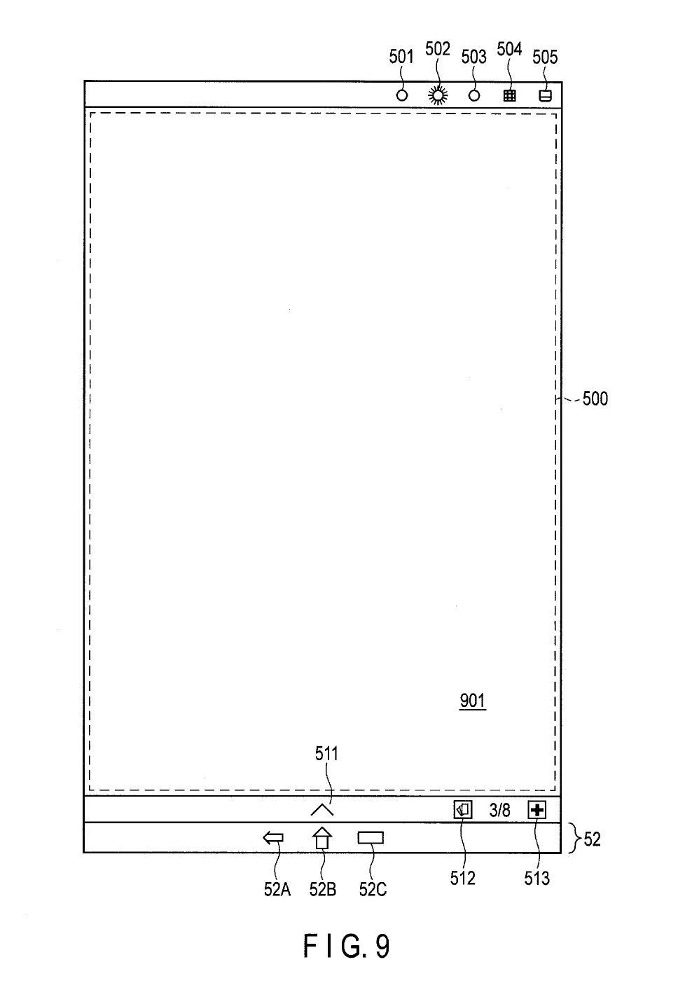

The handwritten note application program 202 can detect various gestures performed on a note preview screen by a user. For example, the handwritten note application program 202 changes a page to be displayed at the top to an arbitrary page (page feeding or page returning) in response to detection of a gesture. Also, the handwritten note application program 202 selects the top page and displays the page editing screen shown in FIG. 9 instead of the note preview screen in response to detection of a gesture performed on the top page (for example, tap gesture), that of a gesture performed on the stylus icon 771 (for example, tap gesture), or that of a gesture performed on the page edit button 82D (for example, tap gesture).

The page editing screen of FIG. 9 is a screen configured to create a new page (handwritten page) and to browse and edit an existing page. If the page 901 on the note preview screen of FIG. 8 is selected, a content of the page 901 is displayed on the page editing screen, as shown in FIG. 9.

On the page editing screen, a rectangular area 500 surrounded by broken lines is a handwriting input area in which handwriting input can be performed. In the handwriting input area 500, an input event from the digitizer 17C is used for displaying (drawing) a handwritten stroke, and is not used as an event for indicating a gesture such as a tap. On the other hand, on the page editing screen, the input event from the digitizer 17C can be used also as an event indicating a gesture such as a tap in an area other than the handwriting input area 500.

An input event from the touchpanel 17B is not used for displaying (drawing) a handwritten stroke, and is used as an event for indicating a gesture such as a tap and a swipe.

A quick selection menu comprising three types of pen 501 to 503 pre-registered by a user, a range selection pen 504 and an eraser pen 505 is further displayed on the page editing screen. Here, a case where a black pen 501, a red pen 502 and a marker 503 are pre-registered by a user is assumed. The user can switch the type of pen to be used by tapping a pen (button) in the quick selection menu with the stylus 100 or a finger. For example, if the handwriting input operation using the stylus 100 is performed on the page editing screen in a state where the black pen 501 is selected by a tap gesture performed by a user using the stylus 100 or a finger, the handwritten note application program 202 displays a black stroke (locus) on the page editing screen in accordance with movement of the stylus 100.

The above-described three types of pen in the quick selection menu can be switched also by the operation of a side button of the stylus 100. Combinations of a color, a thickness (width), etc., of a frequently-used pen can be set for each of the above-described three types of pen in the quick selection menu.

A menu button 511, a page returning button 512 and a page feeding button 513 are further displayed on the page editing screen. The menu button 511 is a button for displaying a menu.

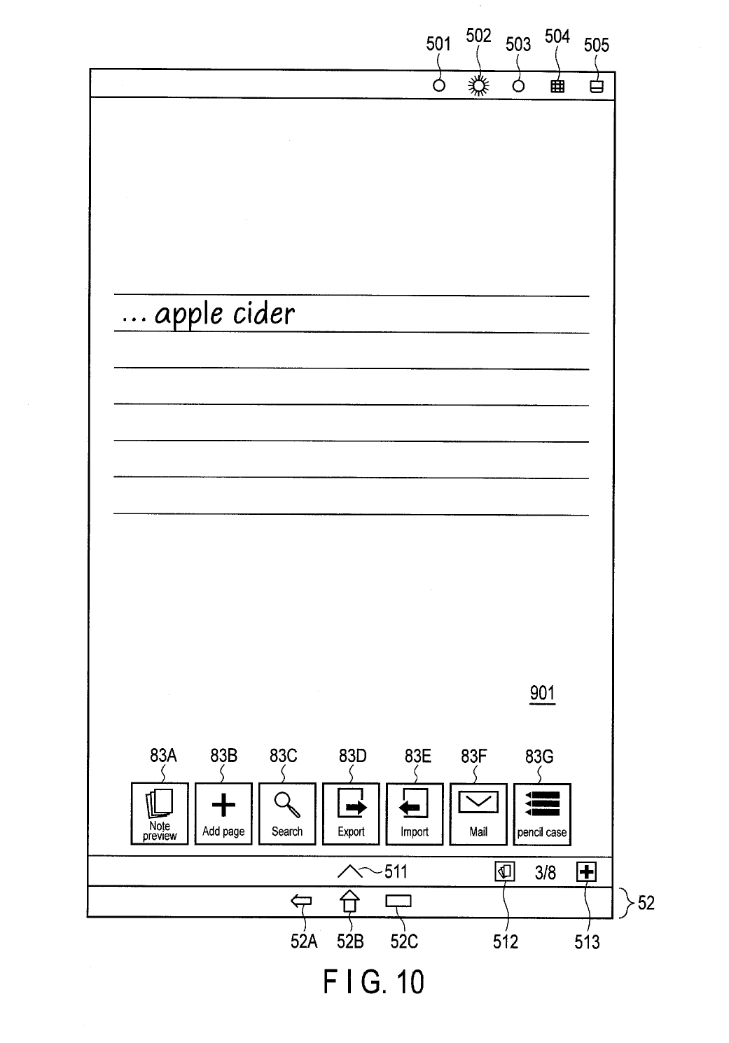

FIG. 10 shows a group of software buttons displayed on a page editing screen as a menu by an operation of the menu button 511.

When the menu button 511 is operated, a note preview button 83A, an add page button 83B, a search button 83C, an export button 83D, an import button 83E, an e-mail button 83F and a pen case button 83G are displayed as a menu on the page editing screen, as shown in FIG. 10.

The note preview button 83A is a button for returning to the note preview screen. The add page button 83B is a button for adding a new page. The search button 83C is a button for opening a search screen. The export button 83D is a button for displaying a submenu for export. The import button 83E is a button for displaying a submenu for import. The e-mail button 83F is a button for starting processing of converting a handwritten page displayed on the page editing screen into text and transmitting it by an e-mail. The pen case button 83G is a button for calling up a pen setting screen on which a color (color of a drawn line), a thickness (width) (thickness [width] of a drawn line), etc., of each of the three types of pen in the quick selection menu can be changed.

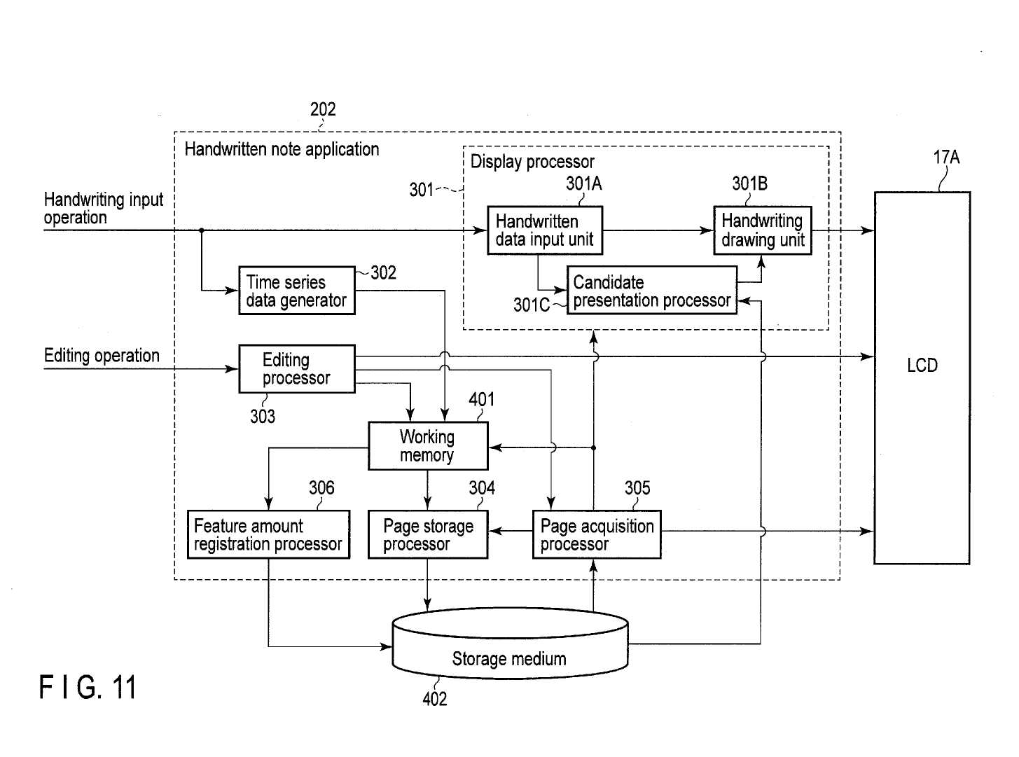

Next, a function configuration of the handwritten note application program 202 will be described with reference to FIG. 11.

The handwritten note application program 202 is a WYSIWYG application which can handle handwritten document data. The handwritten note application program 202 includes, for example, a display processor 301, a time-series data generator 302, an editing processor 303, a page storage processor 304, a page acquisition processor 305, a feature amount registration processor 306, a working memory 401, etc. The display processor 301 includes a handwritten data input unit 301A, a handwriting drawing unit 301B and a candidate presentation processor 301C.

The above-described touchpanel 17B is configured to detect generation of an event such as “touch (contact)”, “move (slide)” and “release”. “Touch (contact)” is an event indicating contact of an object (finger) on a screen. “Move (slide)” is an event indicating that a contact position is changed while an object (finger) is in contact with a screen. “Release” is an event indicating that an object (finger) is lifted from a screen.

The above-described digitizer 17C is also configured to detect the generation of the event such as “touch (contact)”, “move (slide)” and “release”. “Touch (contact)” is an event indicating contact of an object (stylus 100) on a screen. “Move (slide)” is an event indicating that a contact position is changed while an object (stylus 100) is in contact with a screen. “Release” is an event indicating that an object (stylus 100) is lifted from a screen.

The handwritten note application program 202 displays a page editing screen for creating, browsing and editing handwritten page data on the touchscreen display 17.

The display processor 301 and the time-series data generator 302 receives the event of “touch (contact)”, “move (slide)” or “release” generated by the digitizer 17C in order to detect a handwriting input operation. The touch (contact) event includes coordinates of a contact position. The move (slide) event includes coordinates of a contact position of a destination. Thus, the display processor 301 and the time-series data generator 302 can receive a coordinate string corresponding to a locus of motion of a contact position from the digitizer 17C.

The display processor 301 displays a handwritten stroke on a screen in accordance with movement of an object (stylus 100) on a screen which is detected using the digitizer 17C. A locus of the stylus 100 when the stylus 100 is in contact with a screen, that is, a locus of each stroke is displayed on a page editing screen by the display processor 301.

The time-series data generator 302 receives the above-mentioned coordinate string output from the digitizer 17C, and generates handwritten data comprising time-series data (coordinate data series) comprising a structure as described in detail with reference to FIG. 4 based on the coordinate string. The time-series data generator 302 temporarily stores the generated handwritten data in a working memory.

The editing processor 303 executes processing for editing a currently-displayed handwritten page. That is, the editing processor 303 executes editing processing comprising processing of adding a new stroke (new handwritten character, new handwritten mark, etc.) to a currently-displayed handwritten page in accordance with an editing operation and a handwriting input operation performed by a user on the touchscreen display 17, processing of deleting or moving at least one stroke in a plurality of strokes being displayed, etc. Furthermore, the editing processor 303 updates time-series data in the working memory 401 to reflect a result of the editing processing in time-series data being displayed.

The page storage processor 304 stores handwritten page data comprising a plurality of stroke data items corresponding to a plurality of handwritten strokes on a handwritten page being created in a storage medium 402. For example, the storage medium 402 may be a storage device in the tablet computer 10, and may be a storage device of a server computer 2.

The page acquisition processor 305 acquires arbitrary handwritten page data from the storage medium 402. The acquired handwritten page data is transmitted to the display processor 301. The display processor 301 displays a plurality of strokes corresponding to a plurality of stroke data items included in the handwritten page data on a screen.

When a handwritten document (data) is stored in the storage medium 402 by the page storage processor 304, the feature amount registration processor 306 converts all strokes constituting the handwritten document into a character string (word) by executing character recognition processing on a set of strokes constituting the handwritten document. The feature amount registration processor 306 adopts the character string obtained by the conversion as a keyword, associates the keyword, a character recognition result with respect to each set of strokes obtained by integrating each stroke of a set of strokes converted into the keyword in a handwritten document (that is, set of strokes character-recognized as the keyword by character recognition processing) in chronological order, and the number of strokes in the set of strokes, and registers them in a feature suggestion table. Also, the feature amount registration processor 306 associates the converted character string (keyword) and stroke data corresponding to the set of strokes converted into the character string, and registers them in a keyword suggestion table. It should be noted that the feature suggestion table and the keyword suggestion table are stored, for example, in the storage medium 402.

Next, details of the display processor 301 shown in FIG. 11 will be described.

As described above, the touchscreen display 17 detects a touch operation on a screen by the touchpanel 17B or the digitizer 17C. The handwritten data input unit 301A is a module for inputting a detection signal output from the touchpanel 17B or the digitizer 17C. The detection signal includes coordinate data (X, Y) of a touch position. The handwritten data input unit 301A inputs stroke data corresponding to a handwritten stroke by inputting such a detection signal in chronological order. The stroke data (detection signal) input by the handwritten data input unit 301A is supplied to the handwriting drawing unit 301B.

The handwriting drawing unit 301B is a module for drawing a locus (handwritten script) of handwriting input and displaying it on the LCD 17A of the touchscreen display 17. The handwriting drawing unit 301B draws a line segment corresponding to the locus (handwritten script) of the handwriting input based on a stroke data (detection signal) from the handwritten data input unit 301A.

If the stroke data input by the handwritten data input unit 301A corresponds to the stroke handwritten on the above-described page editing screen (handwriting input area 500), the stroke data is supplied also to the candidate presentation processor 301C. If the stroke data is input by the handwritten data input unit 301A in this manner, the candidate presentation processor 301C displays a plurality of sets of strokes specified based on at least one handwritten stroke (that is, stroke data which has been input when the stroke data supplied from the handwritten data input unit 301A is input) in a candidate presentation area on a page editing screen as a candidate for handwriting input by a user. The plurality of sets of strokes displayed as the candidate for the handwriting input represents, for example, a handwritten character string, and includes a set of strokes corresponding to a shape of at least one handwritten stroke. It should be noted that the set of strokes displayed as the candidate for the handwriting input is specified with reference to the feature suggestion table and the keyword suggestion table stored in the storage medium 402, as will be described later.

In the following description, a set of strokes displayed as the candidate for the handwriting input in the candidate presentation area on the page editing screen will be referred to simply as a handwriting input candidate.

If the handwriting input candidate is displayed in the candidate presentation area of the page editing screen as described above, a user can select (designate) the handwriting input candidate as a character string, etc., displayed (described) in the handwriting input area 500. If the handwriting input candidate displayed in the candidate presentation area is selected by the user, the handwriting drawing unit 301B displays the handwriting input candidate in the handwriting input area 500 on the page editing screen. At this moment, the handwriting drawing unit 301B displays a handwriting input candidate in the handwriting input area 500 based on coordinates of the handwriting input candidate (set of strokes) displayed in the candidate presentation area as described above. It should be noted that the coordinates of the set of strokes are relatively determined based on time-series coordinates included in already input stroke data (that is, stroke already handwritten in the handwriting input area 500).

Although it is not shown in FIG. 11, the handwritten note application program 202 includes a retrieval processor, etc., for executing the above-described handwritten script retrieval, text retrieval, etc., in addition to those mentioned above.

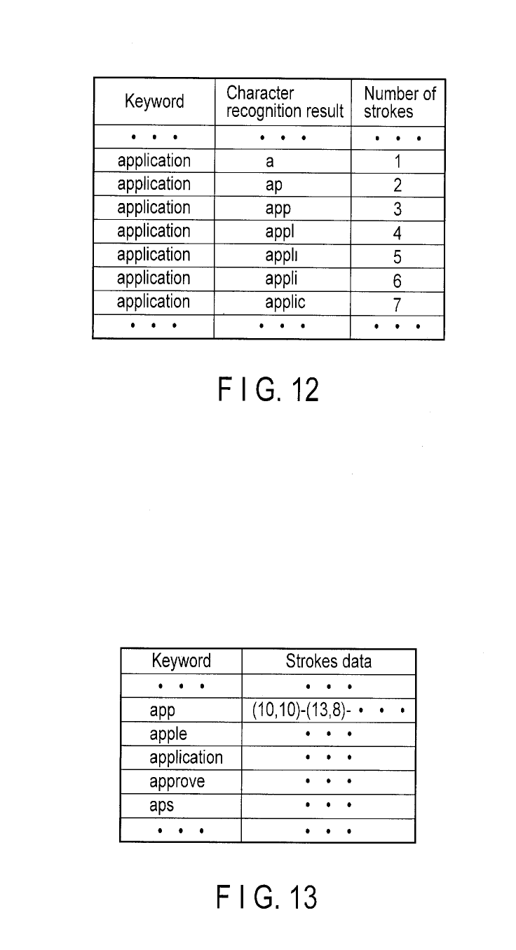

FIG. 12 shows an example of a structure of data of a feature suggestion table stored in the above-described storage medium 402. As described in FIG. 12, the keyword, the character recognition result and the number of strokes are associated and held (registered) in the feature suggestion table. The keyword is a character string (word) equivalent to the above-described handwriting input candidate. The character recognition result indicates a character recognition result with respect to a set of strokes which is part of a set of strokes character-recognized as a keyword associated with the character recognition result. The number of strokes indicates the number of strokes (that is, stroke count) of a set of strokes in which a character recognition result associated with the number of strokes is obtained.

In the example shown in FIG. 12, for example, the keyword “application”, character recognition result “a” and number of strokes “1” are associated and held in the feature suggestion table. This indicates that in a case where a set of strokes character-recognized as the keyword “application” is handwritten by a user, if character recognition processing is performed when the first stroke is handwritten, the character recognition result is “a”.

Also, for example, the keyword “application”, character recognition result “p” and number of strokes “2” are associated and held in the feature suggestion table. This indicates that in a case where the set of strokes character-recognized as the keyword “application” is handwritten by the user, if the character recognition processing is performed when the second stroke is handwritten, the character recognition result is “p”.

It should be noted that the example shown in FIG. 12 is provided on the premise that each of characters “a” and “p” are handwritten in one stroke.

In this manner, character recognition results obtained each time the number of strokes (that is, stroke count) constituting, for example, the keyword “application” increases by one is held in the feature suggestion table. That is, as described above, the character recognition result with respect to each set of strokes obtained by integrating each stroke of a set of strokes character-recognized as a keyword in chronological order and the number of strokes in the set of strokes are associated with the keyword and held in the feature suggestion table.

Although it will be described in detail later, when the handwriting input candidate is displayed, retrieval is performed using the character recognition result and the number of strokes (that is, stroke count) as a key, as described above.

Although the keyword “application” is here described, the character recognition result and the number of strokes are associated and held in the feature suggestion table in the same manner as for other keywords.

FIG. 13 shows an example of a data structure of the keyword suggestion table stored in the above-described storage medium 402. As shown in FIG. 13, a keyword and stroke data which are main keys are associated and held (registered) in the keyword suggestion table. The keyword is a character string (word) equivalent to the above-described handwriting input candidate. The stroke data is data corresponding to the set of strokes character-recognized as the keyword associated with the stroke data (binary data of the stroke).

In the example shown in FIG. 13, for example, the keyword “app” and stroke data “(10, 10)-(13, 8)- . . . ” are associated and held in the keyword suggestion table. This indicates that stroke data corresponding to the set of strokes character-recognized as the keyword “app” is “(10, 10)-(13, 8)- . . . ”. As described above, the stroke data includes a plurality of coordinates corresponding to sampling points on a locus of a stroke.

Although the keyword “app” is here described, the stroke data is associated and held in the keyword suggestion table in the same manner as for other keywords.

An operation of the tablet computer 10 according to this embodiment will be hereinafter described. Of processing executed by the tablet computer 10 according to this embodiment, feature amount registration processing and candidate presentation processing will be described.

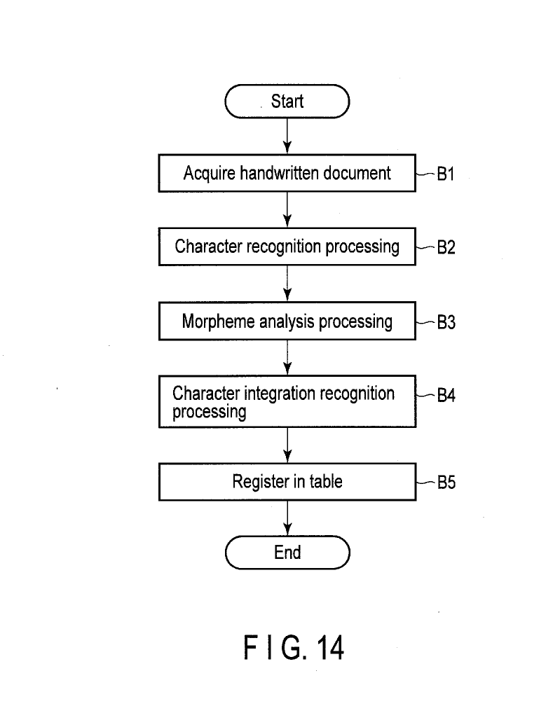

First, processing procedures of the feature amount registration processing will be described with reference to the flowchart of FIG. 14. It should be noted that the feature amount registration processing is executed by the feature amount registration processor 306 when the above-described handwritten document (data) is stored in the storage medium 402.

In the feature amount registration processing, the feature amount registration processor 306 acquires a handwritten document, for example, from the working memory 401 when the handwritten document is stored in the storage medium 402 by the page storage processor 304 (block B1). It should be noted that the handwritten document is constituted of a set of strokes handwritten by a user in the handwriting input area 500 on the above-described page editing screen, and includes stroke data corresponding to the set of strokes.

Next, the feature amount registration processor 306 executes character recognition processing on (a set of strokes corresponding to stroke data included in) the acquired handwritten document (block B2). This causes the set of strokes constituting the handwritten document to be converted into a character string. At this moment, (stroke data corresponding to) each stroke constituting the handwritten document is associated with a character to which the stroke in a character string converted by executing the character recognition processing belongs (character constituted by the stroke).

The feature amount registration processor 306 executes morpheme analysis processing on the converted character string (block B3). This causes the converted character string to be divided into words. At this moment, the feature amount registration processor 306 specifies a set of strokes belonging to each word obtained by the division of the morpheme analysis processing based on a stroke associated with each word in the above-described character string.

Next, the feature amount registration processor 306 executes character integration recognition processing on the set of strokes belonging to each word divided in the morpheme analysis processing (block B4). The character integration recognition processing is processing for acquiring a character recognition result (character string) which is a feature amount for each stroke.

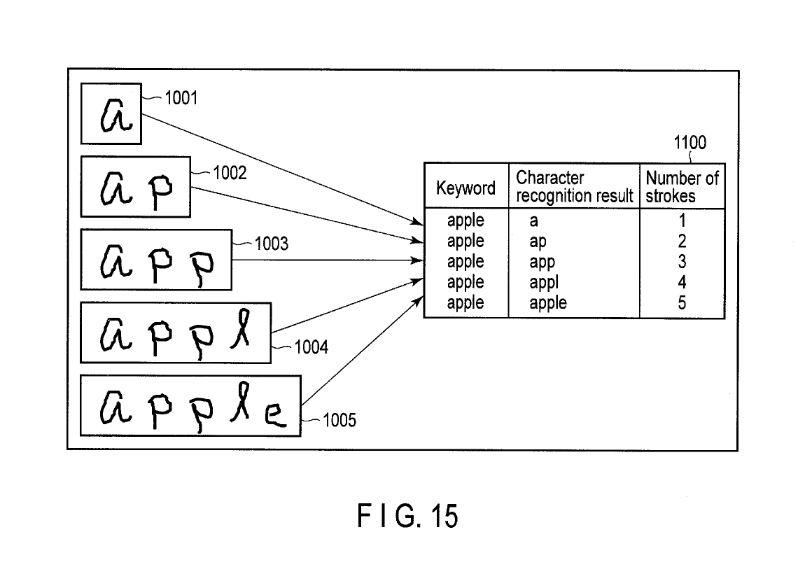

Here, the character integration recognition processing will be specifically described with reference to FIG. 15. Here, a case where the character integration recognition processing is executed on a set of strokes belonging to the keyword “apple” will be described for convenience.

In this case, a character recognition result is “a” when character recognition processing is executed on stroke (set) 1001 whose number of strokes (stroke count) is one.

Next, a character recognition result is “ap” when character recognition processing is executed on set of strokes 1002 whose number of strokes (stroke count) is two.

Similarly, a character recognition result is “app” when character recognition processing is executed on set of strokes 1003 whose number of strokes (stroke count) is three.

Also, a character recognition processing result is “appl” when character recognition processing is executed on set of strokes 1004 whose number of strokes (stroke count) is four.

Furthermore, a character recognition processing result is “apple” when character recognition processing is executed on set of strokes 1005 whose number of strokes (stroke count) is five.

A character integration recognition result 1100 shown in FIG. 15 can be obtained when the character integration recognition processing is executed on the set of strokes belonging to the keyword “apple” as described above. The character integration recognition result 1100 includes a keyword, a character recognition result with respect to a set of strokes and the number of strokes in the set of strokes.

Although the character integration recognition processing is executed on a set of strokes belonging to one keyword in the description of the above-mentioned block B4, the character integration recognition processing may be executed on a character string comprising a plurality of keywords which can be handled as one unit.

Back to FIG. 14, the feature amount registration processor 306 registers various types of data in the above-described feature suggestion table and keyword suggestion table based on the acquired character integration recognition result 1100 (block B5).

Specifically, the feature amount registration processor 306 associates a keyword (word), a character recognition result and the number of strokes which are included in the character integration recognition result 1100 and registers them in the feature suggestion table.

Also, the feature amount registration processor 306 registers a keyword (word) included in the character integration recognition result 1100 and stroke data corresponding to a set of strokes belonging to the keyword in the keyword suggestion table.

In the above-described block B5, if the same data (for example, keyword) is already held in the feature suggestion table and the keyword suggestion table, registration processing of the data is omitted.

As described above, feature amount registration processing allows necessary data used in candidate presentation processing to be described later to be automatically registered in the feature suggestion table and the keyword suggestion table when the handwritten document is stored in the storage medium 402.

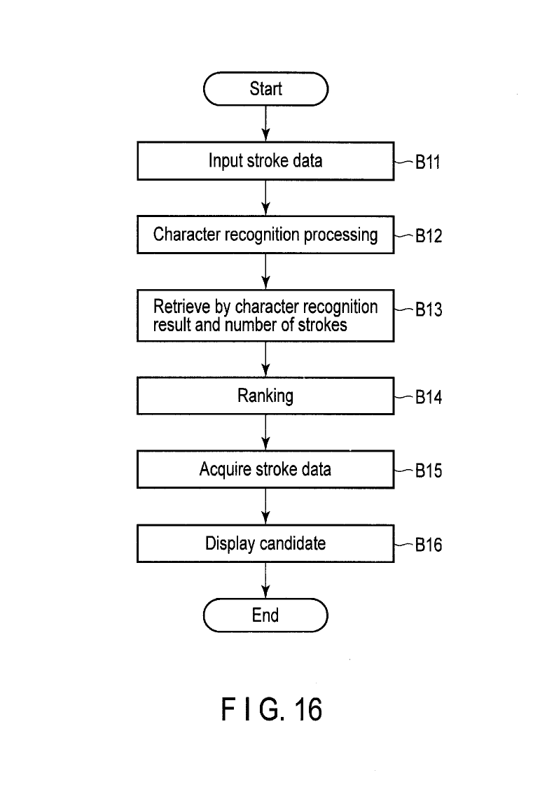

Next, processing procedures of the candidate presentation processing will be described with reference to the flowchart of FIG. 16. It should be noted that the candidate presentation processing is executed by the candidate presentation processor 301C, when stroke data corresponding to a stroke handwritten in the handwriting input area 500 on the above-described page editing screen is input. Also, the candidate presentation processing is executed every time one stroke is handwritten in the handwriting input area 500.

In the candidate presentation processing, the candidate presentation processor 301C inputs stroke data corresponding to one stroke handwritten by a user in the handwriting input area 500 on the page editing screen (block B11). The stroke data input in block B11 is hereinafter referred to as target stroke data.

Next, the candidate presentation processor 301C executes character recognition processing on a set of strokes corresponding to stroke data which has been input when the target stroke data is input (that is, at least one stroke handwritten in the handwriting input area 500) (block B12). Specifically, if the target stroke data is, for example, stroke data corresponding to an n^{th} stroke (n is an integer of one or more) of a handwritten character string, the candidate presentation processor 301C executes character recognition processing on a set of first to n^{th} strokes. This causes the candidate presentation processor 301C to acquire a character recognition result. In this embodiment, the character recognition result is used as a feature amount representing a feature of (the shape of) the set of first to n^{th} strokes. However, in this embodiment, the candidate presentation processor 301C executes the character recognition processing after dividing the set of first to n^{th} strokes every m strokes (m≦n). That is, the candidate presentation processor 301C acquires a plurality of character recognition results obtained by dividing the set of first to n^{th} strokes every m strokes. For example, if n is ten and m is five, the candidate presentation processor 301C can acquire a character recognition result with respect to a set of first to fifth strokes and a character recognition result with respect to a set of sixth to tenth strokes by the above-described character recognition processing. Also, although, here, the set of first to n^{th} strokes is divided every m strokes, the candidate presentation processor 301C may execute the character recognition processing after dividing the set of first to n^{th} strokes by, for example, each punctuation mark (for example, Japanese period and comma, quotation marks, comma, period, etc.). For example, a method of determining whether input stroke corresponds to a punctuation mark or not by comparing the size (length) of the input stroke and that of already input stroke can be used. Also, regarding the stroke corresponding to the above-described punctuation mark, when determining that the stroke input (described) in the handwriting input area 500 corresponds to the punctuation mark, the candidate presentation processor 301C may further include a function of executing pseudo-settlement processing on a stroke input (described) before the stroke corresponding to the punctuation mark.

Also, although, here, the character recognition processing is executed after the set of first to n^{th} strokes is divided every m strokes, the candidate presentation processor 301C may execute the character recognition processing by, for example, shifting a stroke which is a base point for character recognition. Specifically, the candidate presentation processor 301C may execute character recognition processing on the first stroke if the first stroke is input, execute character recognition processing on a set of first and second strokes and the second stroke if the second stroke is input, and execute character recognition processing on a set of first to n^{th} strokes, a set of second to n^{th} strokes, . . . , a set of n−1^{th} to n^{th} strokes and an n^{th} stroke if the n^{th} stroke is input.

It should be noted that the first stroke is specified based on, for example, the positions of other strokes handwritten in the handwriting input area 500.

Subsequently, the candidate presentation processor 301C retrieves a keyword from a feature suggestion table based on an acquired character recognition result and the number of strokes in a set of strokes of which the character recognition result is acquired (block B13). In this case, the candidate presentation processor 301C associates the acquired character recognition result and the number of strokes (that is, stroke count) in the set of strokes of which the character recognition result is acquired, and retrieves a keyword held in the feature suggestion table.

Next, the candidate presentation processor 301C ranks each of retrieved keywords (block B14). Since the ranking will be described later in detail, the detailed description thereof is here omitted.

Subsequently, the candidate presentation processor 301C acquires stroke data corresponding to the set of strokes constituting the retrieved keyword (block B15). Specifically, the candidate presentation processor 301C acquires the stroke data held in the keyword suggestion table in association with the retrieved keyword.

After that, the candidate presentation processor 301C displays a handwriting input candidate by drawing the retrieved keyword and the acquired stroke data on a display (screen) (block B16). In this case, the retrieved keyword is displayed as text, and the acquired stroke data is displayed as a handwritten character string.

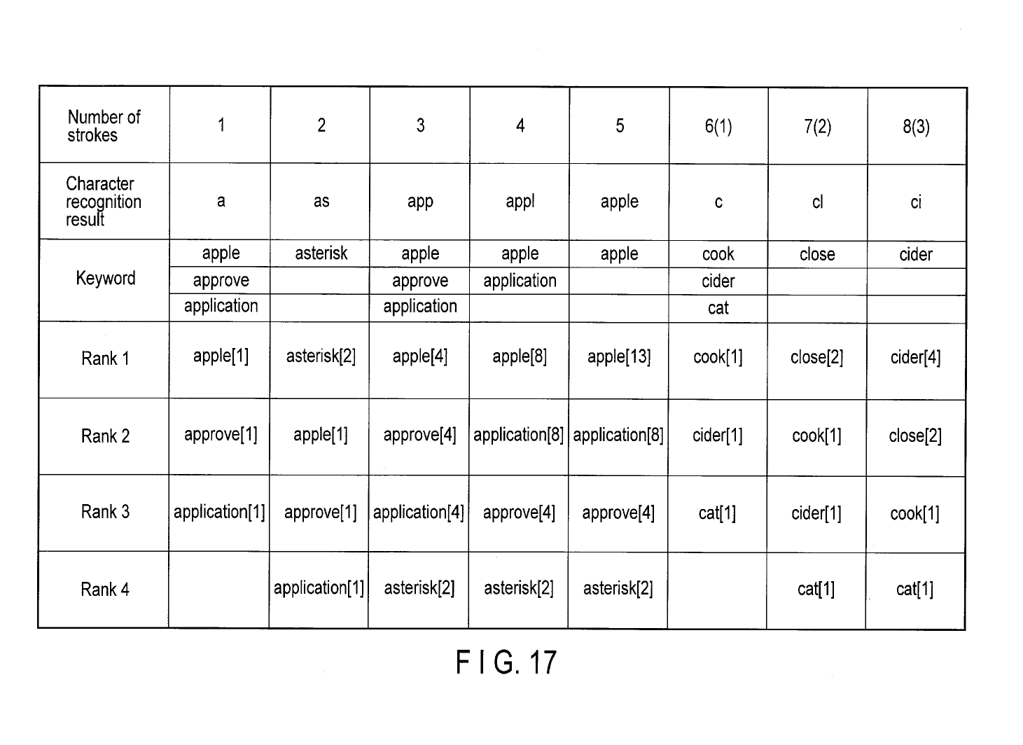

Here, the ranking of keywords will be described in detail with reference to FIG. 17.

In this embodiment, for example, the ranking is performed to display keywords (handwriting input candidates) comprising higher total scores at a higher rank (that is, display in the order of Ranks 1 to 4 in FIG. 17) by integrating scores every time strokes are handwritten such that n scores (points) are added to a keyword (keyword obtained in matching of an n^{th} stroke) retrieved when an n^{th} stroke is input.

Also, in this embodiment, as described above, the character recognition processing is executed after the set of first to n^{th} strokes is divided every m strokes. Thus, ranking for newly adding scores every m strokes is performed also in the ranking of keywords.

In FIG. 17, a case where a user inputs the character string “apple cider” by handwriting is assumed. Further, here, a case where of the above-described character string “apple cider”, the character string “apple ci” is input by the user is assumed. Also, here, a case where the value of the above-described m is predetermined to be five is assumed.

As shown in FIG. 17, a character recognition result with respect to the first stroke is “a”, a character recognition result with respect to a set of first and second strokes is “as”, a character recognition result with respect to a set of first to third strokes is “app”, a character recognition result with respect to a set of first to fourth strokes is “appl”, and a character recognition result with respect to a set of first to fifth strokes is “apple”. The reason why the character recognition result with respect to the set of first and second strokes is not “ap” but “as” is, for example, because a character which is character-recognized not as “p” but as “s” is handwritten and input as the second stroke although “p” should have been handwritten and input by the user. Also, a character recognition result with respect to the sixth stroke (first stroke of a new character recognition result) is “c”. Similarly, a character recognition result with respect to a set of sixth and seventh strokes (second stroke of the new character recognition result) is “cl”. The reason why the character recognition result of the sixth and seventh strokes is “cl” is because the candidate presentation processor 301C erroneously recognized “l (vertical bar)” which is the first stroke of letter “i” to be alphabet “l” in the character recognition processing. A character recognition result with respect to a set of sixth to eighth strokes (third stroke of the new character recognition result) is “ci”.

First, if the first stroke (data) is input, the character recognition result is “a”. Thus, for example, “apple”, “approve” and “application” are retrieved as keywords in the processing of the above-described block B13. In this case, a stroke count (number of strokes) (here, one) is added to each of the retrieved keywords “apple”, “approve” and “application” as a score for ranking. In FIG. 17, the value enclosed in brackets [ ] represents a score added to each keyword.

Next, if the second stroke (data) is input, the character recognition result is “as”. Thus, for example, “asterisk” is retrieved from the feature suggestion table as a keyword in the processing of the above-described block B13. In this case, a stroke count (here, two) is added to the retrieved keyword “asterisk” as a score for ranking. It should be noted that the scores of the keywords “apple”, “approve” and “application” not retrieved when the second stroke is input are one as well as when the first stroke is input (that is, maintained).

Next, if the third stroke (data) is input, the character recognition result is “app”. Thus, for example, “apple”, “approve” and “application” are retrieved from the feature suggestion table as keywords in the above-described block B13. In this case, a stroke count (here, three) is added to the retrieved keywords “apple”, “approve” and “application” as a score for ranking. When the score is added to the keywords “apple”, “approve” and “application” in this manner, the scores of the keywords “apple”, “approve” and “application” are added to the scores at the time of the first stroke and become four in total. It should be noted that the score of the keyword “asterisk” not retrieved when the third stroke is input is two as well as when the second stroke is input (that is, maintained).

Next, if the fourth stroke (data) is input, the character recognition result is “appl”. Thus, for example, “apple” and “application” are retrieved from the feature suggestion table as keywords in the above-described block B13. In this case, a stroke count (here, four) is added to the retrieved keywords “apple” and “application” as a score for ranking. When the score is added to the keywords “apple” and “application” in this manner, the scores of the keywords “apple” and “application” are added to the scores at the time of the third stroke and become eight. It should be noted that the scores of the keywords “approve” and “asterisk” not retrieved when the fourth stroke is input are four and two, respectively, as well as when the third stroke is input (that is, maintained).

Next, if the fifth stroke (data) is input, the character recognition result is “apple”. Thus, for example, “apple” is retrieved from the feature suggestion table as a keyword in the above-described block B13. In this case, a stroke count (here, five) is added to the retrieved keyword “apple” as a score for ranking. When the score is added to the keyword “apple” in this manner, the score of the keyword “apple” is added to the score at the time of the fourth stroke and become 13. It should be noted that the scores of the keywords “application”, “approve” and “asterisk” not retrieved when the fifth stroke is input are eight, four and two, respectively, as well as when the fourth stroke is input.

Next, if the sixth stroke (data) is input, the value of the above-described m is five. Thus, a score different from the already added scores is newly added to the strokes (set) from the sixth stroke onward. In this case, since the character recognition result is “c”, for example, “cook”, “cider” and “cat” are retrieved from the feature suggestion table as keywords in the above-described block B13. In this case, a new stroke count (new number of strokes) (that is, not six but one) is added to the retrieved keywords “cook”, “cider” and “cat” as a score for ranking. In FIG. 17, the value enclosed in brackets ( ) represents a stroke count (number of strokes) of a new stroke constituting a character recognition result different from the already-described character recognition result “apple”.

Next, if the seventh stroke (data) is input, the character recognition result is “cl”. Thus, for example, “close” is retrieved from the feature suggestion table as a keyword in the above-described block B13. In this case, a new stroke count (new number of strokes) (that is, not seven but two) is added to the retrieved keyword “close” as a score for ranking. It should be noted that the scores of the keywords “cook”, “cider” and “cat” not retrieved when the seventh stroke is input are one as well as when the sixth stroke is input (that is, maintained).

Finally, if the eighth stroke (data) is input, the character recognition result is “ci”. Thus, for example, “cider” is retrieved from the feature suggestion table as a keyword in the above-described block B13. In this case, a new stroke count (new number of strokes) (that is, not eight but three) is added to the retrieved keyword “cider” as a score for ranking. When the score is added to the keyword “cider” in this manner, the score of the keyword “cider” is added to the score at the time of the sixth stroke and become four. It should be noted that the scores of the keyword “cook”, “cat” and “close” not retrieved when the eighth stroke is input are one, one and two, respectively, as well as the seventh stroke is input (that is, maintained).

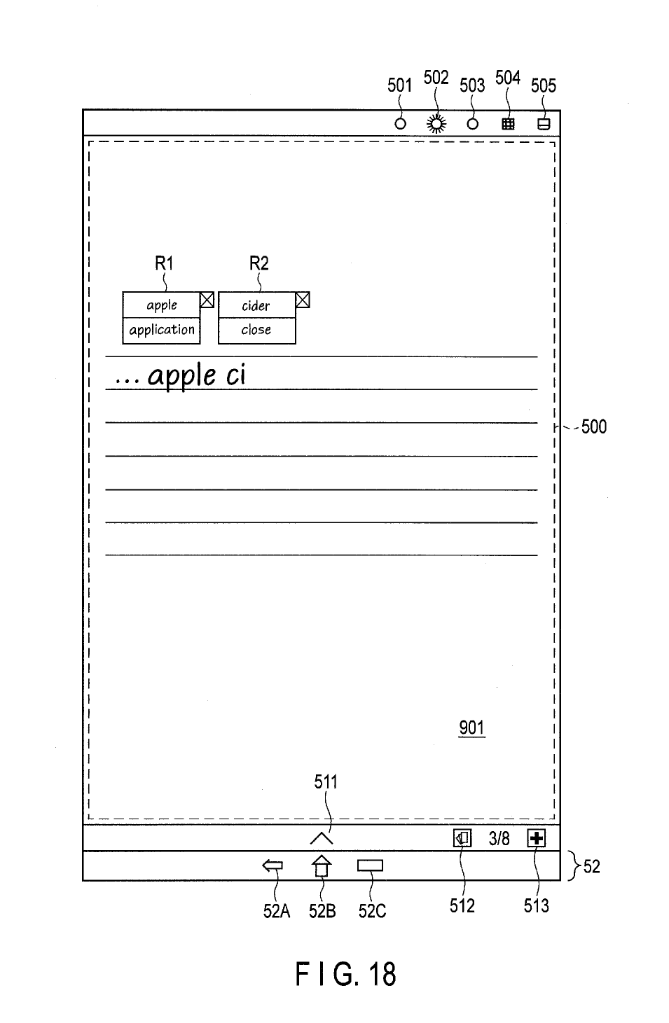

Next, a specific example of the candidate presentation processing according to this embodiment will be described with reference to FIG. 18.

In FIG. 18, a case where a user inputs the character string “apple cider” in the handwriting input area 500 on the page editing screen is assumed. Further, here, a case where of the above-described character string “apple cider”, the character string “apple ci” is input by the user is assumed. Also, here, a case where the value of the above-described m is five is assumed. That is, as already described, a case where the ranking as shown in FIG. 17 is performed by the candidate presentation processor 301C is assumed.

In this case, first, the candidate presentation processor 301C acquires an X-coordinate and a Y-coordinate (hereinafter referred to as first coordinates) of a start point of the first stroke from a plurality of coordinate data items indicated by time-series data included in the first stroke data. Subsequently, since the value of the above-described m is five, the candidate presentation processor 301C acquires an X-coordinate and a Y-coordinate (hereinafter referred to as second coordinates) of a start point of the sixth stroke from a plurality of coordinate data items indicated by time-series data included in the sixth stroke data.

After that, the candidate presentation processor 301C determines (an area comprising) a position obtained by shifting the Y-coordinate of the first coordinates upward by a predetermined value (distance) to be candidate presentation area (hereinafter referred to as first candidate presentation area) R1 for displaying a handwriting input candidate corresponding to a set of first to five strokes (first set of first strokes). Similarly, the candidate presentation processor 301C determines (an area comprising) a position obtained by shifting the Y-coordinate of the second coordinates upward by a predetermined value (distance) to be candidate presentation area (hereinafter referred to as second candidate presentation area) R2 for displaying a handwriting input candidate (second set of second strokes) corresponding to a set of sixth to eighth (eventually, sixth to tenth) strokes.

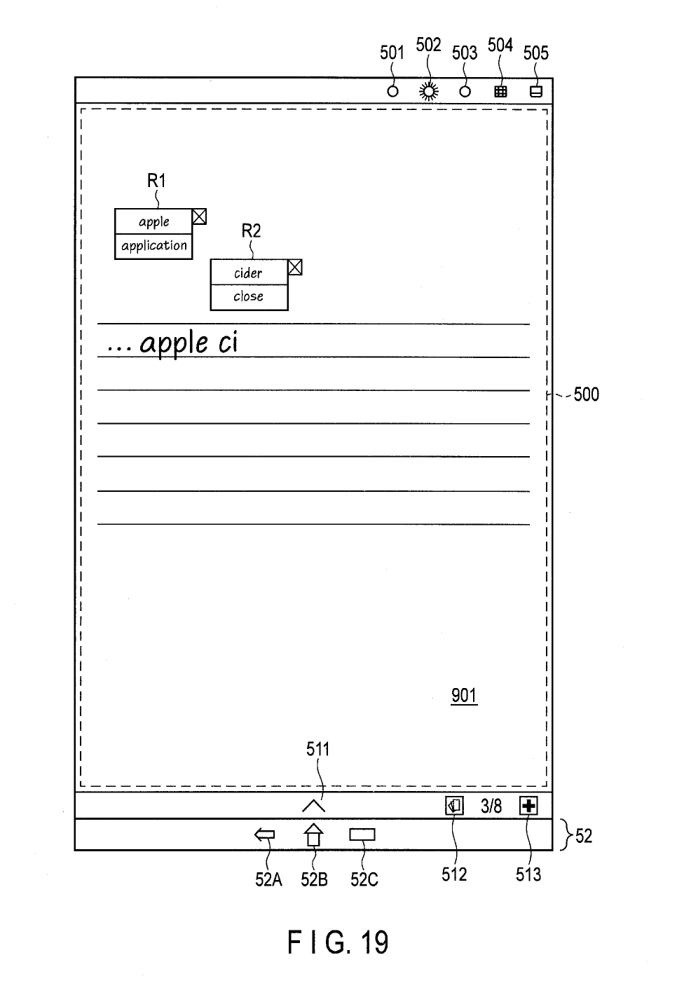

Then, the candidate presentation processor 301C displays handwriting input candidates “apple” and “application” in first candidate presentation area R1 in this order, and handwriting input candidates “cider” and “close” in second candidate presentation area R2 in this order, as shown in FIG. 18, in accordance with the ranking shown in the above-mentioned FIG. 17. It should be noted that first candidate presentation area R1 and second candidate presentation area R2 are not necessarily horizontally arranged in a row, unlike in FIG. 18. For example, each area may be shifted in a Y direction as shown in FIG. 19. In FIG. 19, first candidate presentation area R1 is disposed in an upper direction, and second candidate presentation area R2 is disposed in a lower direction compared to first candidate presentation area R1. However, for example, second candidate presentation area R2 may be disposed in the upper direction, and first candidate presentation area R1 may be disposed in the lower direction compared to second candidate presentation area R2.

The position in which the handwriting input candidate is displayed and the position of a character to be replaced with the handwriting input candidate are associated in this manner. Thus, a user can select the handwriting input candidate after visually identifying which stroke (set) is replaced and with which handwriting input candidate the stroke is replaced (that is, after visually identifying with which of at least one set of strokes the stroke replaced (deleted) by selecting (inputting) each of the set of first strokes and the set of second strokes).

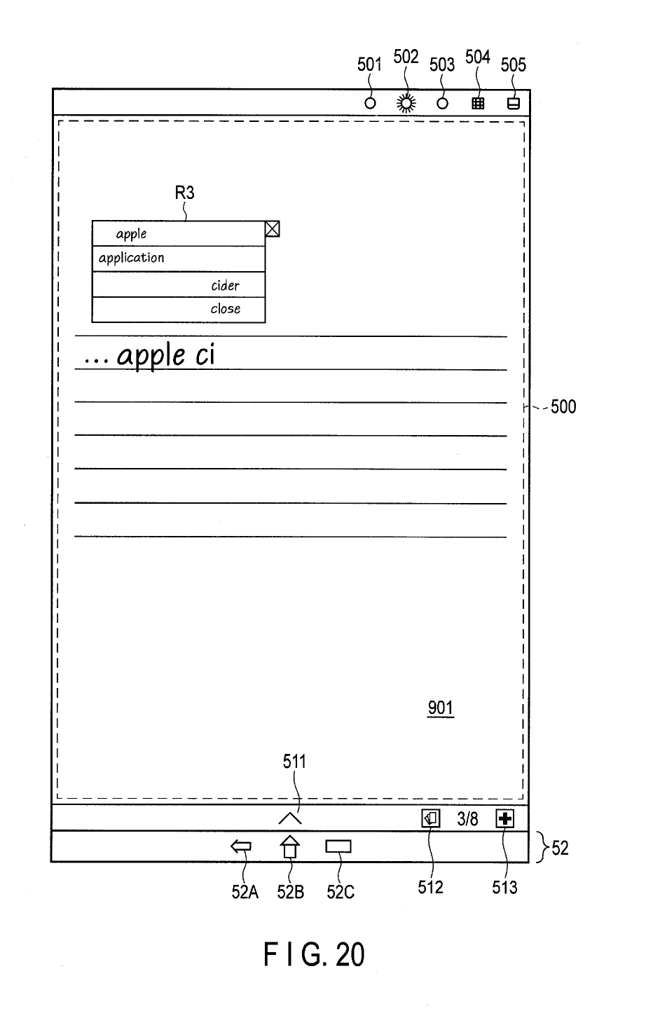

In FIGS. 18 and 19, after the candidate presentation area is divided into the two areas, first candidate presentation area R1 and second candidate presentation area R2, handwriting input candidates are displayed in each area. For example, as shown in FIG. 20, handwriting input candidates may be displayed side by side in one candidate presentation area. That is, handwriting input candidates “apple” and “application” corresponding to the set of first to fifth strokes (in other words, recognition result of the first character) and handwriting input candidates “cider” and “close” corresponding to the set of sixth to eighth strokes (in other words, recognition result of the second character) may be displayed side by side in candidate presentation area R3 in accordance with the positions of the characters to be replaced.

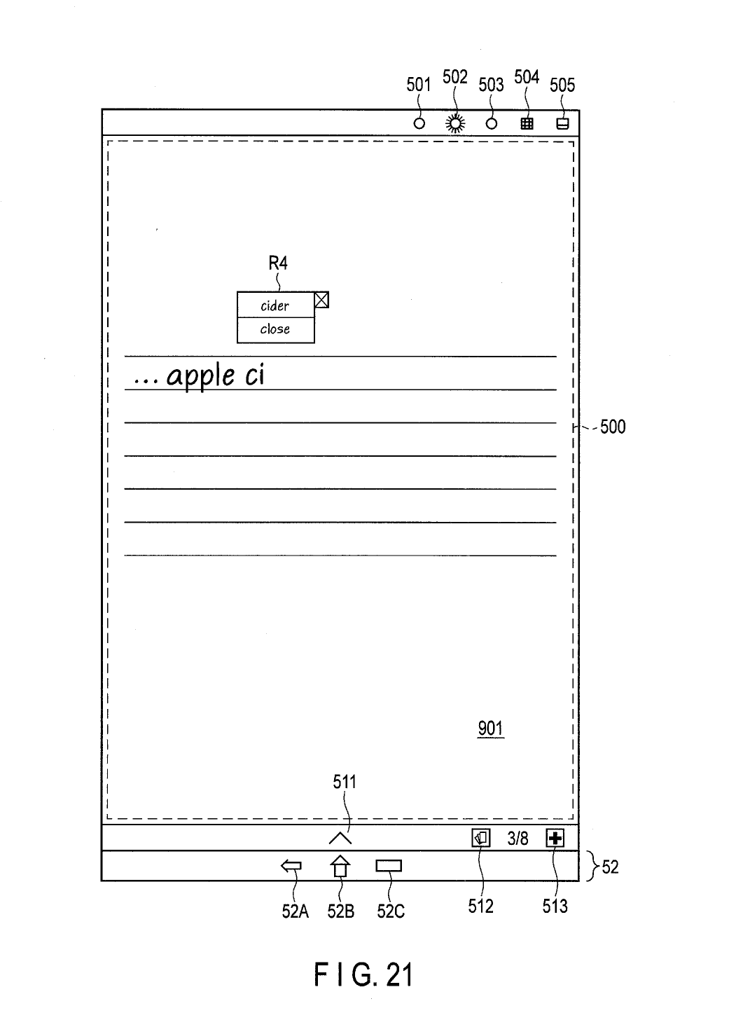

Also, as shown in FIG. 21, only handwriting input candidates “cider” and “close” corresponding to a character recognition result with respect to a set of strokes comprising a stroke finally input (described) at that moment (“ci” in FIG. 21) may be displayed in candidate presentation area R4 located in accordance with the position of the set of strokes, unlike the examples shown in FIGS. 18 to 20.

In FIGS. 18 to 21, which stroke (set) is replaced and with which handwriting input candidate the stroke is replaced are suggested to a user by associating the position in which the handwriting input candidate is displayed with the position of the character to be replaced with the handwriting input candidate. However, which stroke (set) is replaced and with which handwriting input candidate the stroke is replaced may be suggested to a user, for example, by associating the color of the handwriting input candidate to be displayed with the color of the character to be replaced with the handwriting input candidate (that is, by associating the display form of the handwriting input candidate to be displayed with the display form of the character to be replaced with the handwriting input candidate).

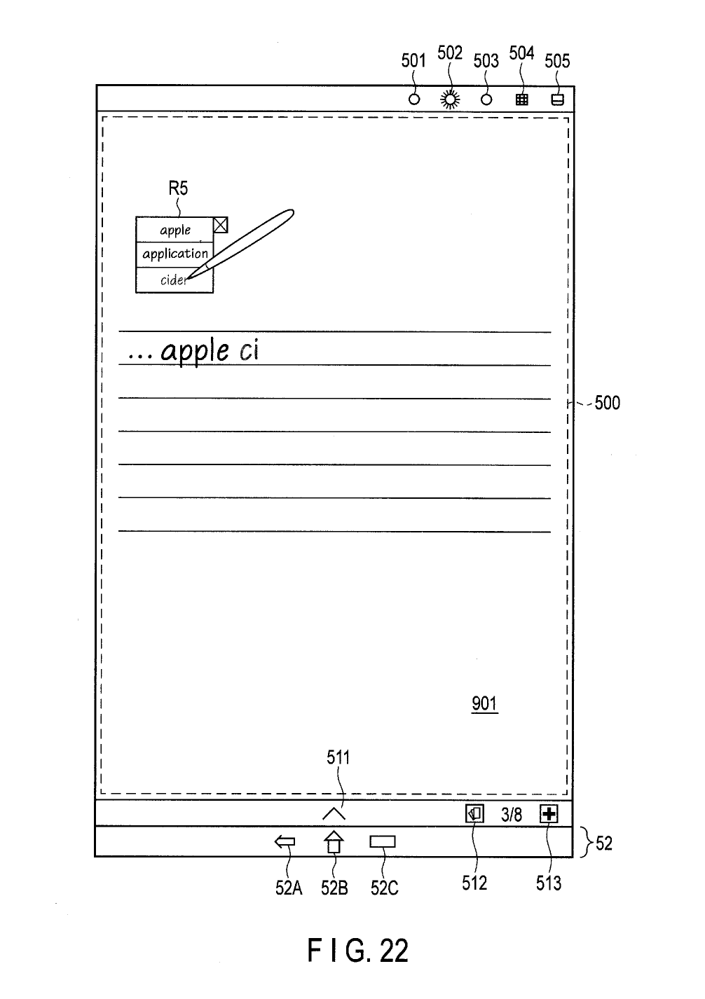

FIG. 22 shows an example of a page editing screen on which the color of the handwriting input candidate to be displayed and the color of the character to be replaced with the handwriting input candidate are associated and displayed. When the stylus 100 is approached on candidate presentation area R5 (in other words, when a hover state of the stylus 100 is detected) after the handwriting input candidate is displayed in the above-described block B16, the candidate presentation processor 301C changes the display color of the handwriting input candidate located in the position of the nib of the stylus 100 and the display color of the character to be replaced with the handwriting input candidate to be the same color, as shown in FIG. 22. At this moment, a handwriting input candidate located in a position different from that of the nib of the stylus 100 is displayed in a color different from that of the handwriting input candidate located in the position of the nib of the stylus 100. If a plurality of handwriting input candidates are located in a position different from that of the nib of the stylus 100, the handwriting input candidates may be all displayed in the same color, or may be displayed in the same color as the display color of the character to be replaced with each handwriting input candidate. Although, here, the display color is changed if the hover state of the stylus 100 is detected, the display color may be changed while, for example, the handwriting input candidate is tapped long with a finger or the stylus 100 (long tap). The long tap indicates an operation of touching a screen long, which is performed mainly, for example, to obtain focus on a predetermined portion on a screen, unlike tap indicating an operation of momentarily touching a screen. By associating the color of the handwriting input candidate to be displayed with the color of the character to be replaced with the handwriting input candidate as shown above, a user can select the handwriting input candidate after visually identifying which stroke (set) is replaced and with which handwriting input candidate the stroke is replaced.

Although in this embodiment, the handwriting input candidate is displayed both by text and by a handwritten character string, the handwriting input candidate may be displayed, for example, by at least one of the text and the handwritten character string.

Also, although in this embodiment, a plurality of handwriting input candidates are displayed on a screen in an arbitrary order if the same score is added to the handwriting input candidates, ranking may be further performed in accordance with, for example, a past appearance frequency. In this case, of a plurality of handwriting input candidates (keywords) to which the same score is added, a handwriting input candidate comprising a higher appearance frequency is preferentially displayed on a screen.

Also, ranking may be further performed in accordance with the number of past selections. In this case, of the plurality of handwriting input candidates to which the same score is added, a handwriting input candidate comprising the larger number of selections is preferentially displayed.

It should be noted that (data of) the above-described appearance frequency or (data of) the number of selections is not necessarily used. Also, the ranking may be performed using either the appearance frequency or the number of selections. Moreover, if the ranking is performed using both the appearance frequency and the number of selections, on which of the appearance frequency and the number of selections priority is placed can also be set.

Also, only part of the handwriting input candidate may be displayed on a screen in accordance with a score (priority) added to the handwriting input candidate. Specifically, for example, only handwriting input candidates to which a score comprising more than one third of the maximum value of the scores added to each of a plurality of handwriting input candidates is added can be displayed on the screen.

Although a case where alphabets are input (described) in the handwriting input area 500 is described in this embodiment, the character input (described) in the handwriting input area 500 may be Hiragana, Katakana, Kanji, etc.

A reading (reading in Kana) table as well as the feature suggestion table and the keyword suggestion table may be held in the storage medium 402 on the assumption that Hiragana, Katakana, Kanji, etc., are input (described) in the handwriting input area 500.

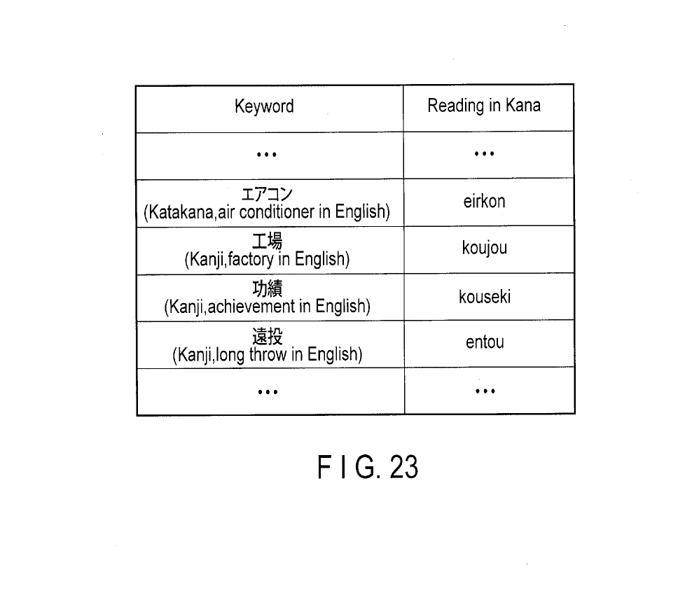

Here, an example of a data structure of the reading table will be described with reference to FIG. 23.

As shown in FIG. 23, a keyword and a reading are associated and held (registered) in the reading table. The keyword is a character string (word) equivalent to the above-described handwriting input candidate. The reading indicates a reading of a keyword associated with the reading.

In the example shown in FIG. 23, for example, the keyword “ [symbol] ” (Katakana, air conditioner in English) and the reading “eirkon” are associated and held in the reading table. This indicates that the reading of the keyword “ [symbol] ” (Katakana, air conditioner in English) is “eirkon”.

Similarly, for example, the keyword “ [symbol] ” (Kanji, factory in English) and the reading “koujou” are associated and held in the reading table. This indicates that the reading of the keyword “ [symbol] ” (Kanji, factory in English) is “koujou”.

Although, here, the keywords “ [symbol] ” (Katakana, air conditioner in English) and “ [symbol] ” (Kanji, factory in English) are described, other keywords are associated with readings and held in the reading table in the same manner.

Also, in the example shown in FIG. 23, the readings are written in Katakana, but may be written in Hiragana.

The reading table is used when the candidate presentation processor 301C retrieves a keyword based on an acquired character recognition result in the same manner as in the processing of the above-described block B13. It should be noted that the ranking in the above-described block B14 is performed also on a keyword retrieved using the reading table. This allows retrieval of a keyword and presentation of a handwriting input candidate based on a reading as well as the number of strokes to be performed.

Since one embodiment described above includes a structure of displaying a handwriting input candidate in a manner that a user can identify which stroke (set) is replaced and with which handwriting input candidate the stroke is replaced, a candidate for a character to be estimated to be input can be effectively presented.

Since the processing of this embodiment can be realized by a computer program, an advantage similar to that of this embodiment can be easily achieved merely by installing the computer program in a computer through a computer-readable storage medium in which the computer program is stored and executing it.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
circuitry configured to:
input stroke data corresponding to strokes of handwriting;
display (1) a first set of first strokes specified based on at least one first stroke of the strokes and (2) a second set of second strokes specified based on at least one second stroke of the strokes as a candidate for handwriting input, the at least one second stroke different from the at least one first stroke; and
when the first set of first strokes or the second set of second strokes is selected, the at least one first stroke used to specify the first set of first strokes or the at least one second stroke used to specify the second set of second strokes is displayed visually distinguishable from other strokes of the strokes.

2. The electronic apparatus of claim 1, wherein
the circuitry is configured to display the first set of first strokes in a first position determined in accordance with a position of the at least one first stroke, or display the second set of second strokes in a second position determined in accordance with a position of the at least one second stroke.

3. The electronic apparatus of claim 1, wherein
the circuitry is configured to display the at least one first stroke in a display form different from a display form of at least some other strokes when the first set of first strokes is selected, or display the at least one second stroke in a display form different from a display form of at least some other strokes when the second set of second strokes is selected.

4. The electronic apparatus of claim 1, wherein
the circuitry is configured to,
display the first set of first strokes and the at least one first stroke in a first color, and strokes other than the first set of first strokes and the at least one first stroke of the plurality of strokes in a different color than the first color, or
display the second set of second strokes and the at least one second stroke in a second color, and strokes other than the second set of second strokes and the at least one second stroke of the plurality of strokes in a different color than the second color.

5. A method comprising:
inputting stroke data corresponding to strokes of handwriting;
displaying (1) a first set of first strokes specified based on at least one first stroke of the strokes and (2) a second set of second strokes specified based on at least one second stroke of the strokes as a candidate for handwriting input, the at least one second stroke different from the at least one first stroke; and
when the first set of first strokes or the second set of second strokes is selected, the at least one first stroke used to specify the first set of first strokes or the at least one second stroke used to specify the second set of second strokes is displayed visually distinguishable from other strokes of the strokes.

6. The method of claim 5, further comprising,
displaying the first set of first strokes in a first position determined in accordance with a position of the at least one first stroke, or displaying the second set of second strokes in a second position determined in accordance with a position of the at least one second stroke.

7. The method of claim 5, further comprising,
displaying the at least one first stroke in a display form different from a display form of at least some other strokes when the first set of first strokes is selected, or displaying the at least one second stroke in a display form different from a display form of at least some other strokes when the second set of second strokes is selected.

8. The method of claim 5, further comprising,
displaying the first set of first strokes and the at least one first stroke in a first color, and strokes other than the first set of first strokes and the at least one first stroke of the plurality of strokes in a different color than the first color, or
displaying the second set of second strokes and the at least one second stroke in a second color, and strokes other than the second set of second strokes and the at least one second stroke of the plurality of strokes in a different color than the second color.

9. A non-transitory computer-readable storage medium storing instructions executed by a computer, wherein the instructions, when executed by the computer, cause the computer to perform:
inputting stroke data corresponding to strokes of handwriting;
displaying (1) a first set of first strokes specified based on at least one first stroke of the strokes and (2) a second set of second strokes specified based on at least one second stroke of the strokes as a candidate for handwriting input, the at least one second stroke different from the at least one first stroke; and
when the first set of first strokes or the second set of second strokes is selected, the at least one first stroke used to specify the first set of first strokes or the at least one second stroke used to specify the second set of second strokes is displayed visually distinguishable from other strokes of the strokes.

10. The storage medium of claim 9, wherein the instructions cause the computer to further perform:
displaying the first set of first strokes in a first position determined in accordance with a position of the at least one first stroke, or displaying the second set of second strokes in a second position determined in accordance with a position of the at least one second stroke.

11. The storage medium of claim 9, wherein the instructions cause the computer to further perform:
displaying the at least one first stroke in a display form different from a display form of at least some other strokes when the first set of first strokes is selected, or displaying the at least one second stroke in a display form different from a display form of at least some other strokes when the second set of second strokes is selected.

12. The storage medium of claim 9, wherein the instructions cause the computer to further perform:
displaying the first set of first strokes and the at least one first stroke in a first color, and strokes other than the first set of first strokes and the at least one first stroke of the plurality of strokes in a different color than the first color, or
displaying the second set of second strokes and the at least one second stroke in a second color, and strokes other than the second set of second strokes and the at least one second stroke of the plurality of strokes in a different color than the second color.
